(19) United States
(12) Patent Application Publication
(10) Pub. No.: US 2023/0310258 A1
(43) Pub. Date: Oct. 5, 2023

(54) MASSAGE MODULE HAVING HEATING FUNCTION

(71) Applicant: BODYFRIEND CO., LTD., Seoul (KR)

(72) Inventors: Gi Won UM, Seoul (KR); Yong Ju KWON, Seoul (KR); Ryang Min LEE, Seoul (KR)

(21) Appl. No.: 18/021,172

(22) PCT Filed: Aug. 30, 2021
(86) PCT No.: PCT/KR2021/011570

§ 371 Date: Feb. 13, 2023

(30) Foreign Application Priority Data
Aug. 31, 2020 (KR) 10-2020-0110201
Oct. 15, 2020 (KR) 10-2020-0133673
Mar. 10, 2021 (KR) 10-2021-0031671

(51) Int. Cl. A61H 15/00

(52) U.S. Cl. CPC A61H 15/0078; A61H 2201/0149; A61H 2201/0207; H05B 1/0213

(57) ABSTRACT

Provided is a massage module having a heating function to transfer heat to the human body through massage performed by applying vibrations or pressure to a body part of a user. The massage module includes a massage unit which applies pressure and heat to the body of the user, the massage unit including: a support shaft member which is fixedly installed on a unit bracket and includes a heat conductive material; a heat generation member for transferring heat to the support shaft member; a cushion member which has an opening formed in the center thereof such that the support shaft member is inserted in the opening, is rotatably installed on the outer surface of the support shaft member, and applies pressure to the body of the user; an insert member which is inserted in the inner circumferential surface of the opening of the cushion member, has a ring shape, and is formed of a heat conductive metal material; and a reinforcing washer which is formed in a ring shape, is inserted in the support shaft member, and is in close contact with one side surface or both side surfaces of the cushion member in the axial direction. so as to resist a torsion stress applied to the cushion member.

### TECHNICAL FIELD

The present invention relates to a massage module, and more particularly, to a massage module having a heating function to transfer heat to a human body through a massage performed by applying vibration or pressure to a user's body part.

### BACKGROUND ART

In recent years, with the improved standards of living and an aging society, interest in the massage apparatus is increasing while people suffering from muscle paralysis or muscle pain due to lack of exercise and stress are increased.

Accordingly, the massage apparatus having various functions and high performance beyond the simple massage function has appeared and satisfies the desire of users.

A chair type massage apparatus (hereinafter, referred to as a “massage chair”) is configured to massage various body parts, which get in contact with the chair, such as neck, back, waist, hips, arms, legs, feet, and the like, using a mechanical massage module and/or an inflatable air cell module.

In general, the massage chair is equipped with an elevatable massage module on a backrest portion. The elevatable massage module performs a massage action of tapping or kneading a user's body while moving up and down from the neck to the waist or the thighs to practice acupressure from the neck to the waist or the thighs of a user who is sitting on the massage chair, thereby relieving fatigue, relaxing muscles, performing spinal correction, and providing a massage.

Recently, researches for maximizing massage effects by providing a massage function and a heating function to a user's body using rollers or balls disposed on the massage module are being carried out.

As described above, in order to provide heat through a massage of the massage module, components for heat generation and heat transfer should be additionally installed in the massage module. However, there is a problem in that the overall structure is complicated and durability of various components of the massage module is degraded if the components for heat generation and heat transfer are not arranged appropriately.

### PATENT LITERATURE

### Patent Documents

Korean Patent Publication No. 10-2021-0007795
Korean Patent No. 10-1479521
Korean Patent No. 10-1832907

### DISCLOSURE

### Technical Problem

Accordingly, the present invention has been made in view of the above-mentioned problems occurring in the related art, and it is an object of the present invention to provide a massage module capable of performing a function of providing heat to a user's body when performing a massage action of tapping or kneading the user's body, and improving durability of various components performing the massage action and the heating function.

### Technical Solution

To accomplish the above-mentioned objects, according to the present invention, there is provided a massage module including: a module base mounted in a massage apparatus; a massage driving unit mounted on the module base to provide at least one among driving forces for vibration, linear motion, rotational motion, and massage position adjustment for massaging a user's body; a unit bracket connect to the massage driving unit; and a massage unit mounted on the unit bracket to apply pressure and heat to the user's body, wherein the massage unit includes: a support shaft member made of a thermally conductive material, and fixed to the unit bracket; a heating member for transferring heat to the support shaft member; a cushion member having an opening formed in the middle thereof so that the support shaft member is inserted thereinto, rotatably mounted on the outer surface of the support shaft member to apply pressure to the user's body; a ring-shaped insert member made of a thermally conductive metal material and inserted into the inner circumferential surface of an opening of the cushion member; and a reinforcing washer of a ring shape fit onto the support shaft member and getting in close contact with one axial side surface or both axial side surfaces of the cushion member to resist torsion stress applied to the cushion member.

According to an aspect of the present invention, the reinforcing washer includes a first reinforcing washer disposed to be in close contact with one side surface of the cushion member facing the unit bracket, and a second reinforcing washer disposed between the other side surface of the cushion member and an end portion of the supporting shaft member.

According to an aspect of the present invention, the massage module further includes a first protection member of a ring shape fit onto the support shaft member, and getting in close contact with the outer surface of the first reinforcing washer to prevent abrasion and deformation of the first reinforcing washer.

According to an aspect of the present invention, the massage module further includes a heat transfer cover mounted between the outer surface of the first protection member and the unit bracket to receive heat from the support shaft member and transfer the heat to the user's body.

According to an aspect of the present invention, the heat transfer cover includes a cover guard formed in a circumferential direction at an edge portion thereof to accommodate and conceal the end portion of the unit bracket, and the outer surface of the cover guard has a curved surface inclined downward toward the unit bracket.

According to an aspect of the present invention, the support shaft member includes a cylindrical body portion of which one end portion is fixedly coupled to the unit bracket, and a flange portion protruding radially outward to the other end portion of the body portion. A second protection member of a ring shape is mounted between the second reinforcing washer and the flange portion to prevent abrasion and deformation of the second reinforcing washer.

According to an aspect of the present invention, the heating member is inserted into a space formed in the support shaft member.

According to an aspect of the present invention, the heating member includes a heater generating heat by electric power supplied from an external control module, a temperature sensor measuring temperature to control the operation of the heater, and a bimetal for automatically cutting off power supply to the heater when the support shaft member is heated beyond a predetermined temperature due to a failure of the temperature sensor and restarting power supply to the heater when the support shaft member is cooled below a predetermined temperature.

According to an aspect of the present invention, the insert member includes a circular ring-shaped inner contour portion mounted along the inner circumferential surface of the opening of the cushion member to be exposed to the outside, an insert portion formed on the outer circumferential surface of the inner contour portion, inserted into the cushion member, and having a plurality of through holes arranged in the circumferential direction so that a portion of the cushion member can be inserted, and protrusion ribs arranged on the insert portion to be spaced apart at a predetermined interval in the circumferential direction of the insert portion.

### Advantageous Effects

The massage module according to the present invention can heat a support shaft member by applying electric power to a heating member when actuating a massage unit to perform a massage action, and transfer heat to a cushion member adjoining the outer surface of the support shaft member, thereby providing heat. In this instance, since one side or both sides of the cushion member in an axial direction is supported by a reinforcing washer, the cushion member maintains its form relatively uniformly without any deformation of the cushion member even if a torsion stress is applied to the cushion member during a kneading action of the massage unit, thereby preventing deformation, damage, and separation of the cushion member.

### DESCRIPTION OF DRAWINGS

FIG. 1 is a perspective view illustrating an example of a massage chair as a massage apparatus to which a massage module of the present invention is applied.

FIG. 2 is a perspective view illustrating a massage module according to an embodiment of the present invention.

FIG. 3 is a perspective view of a massage unit constituting a massage module according to an embodiment of the present disclosure.

FIG. 4 is an exploded perspective view of the massage unit illustrated in FIG. 3.

FIG. 5 is a sectional view of the massage unit illustrated in FIG. 3.

FIG. 6 is a perspective view of an insert member constituting the massage unit illustrated in FIG. 3.

FIG. 7 is a perspective view of a first protection member constituting the massage unit illustrated in FIG. 3.

FIG. 8 is a block diagram illustrating a configuration and an operational example of a heating member constituting the massage unit illustrated in FIG. 3.

### BEST MODE

There is a massage module including: a module base mounted in a massage apparatus; a massage driving unit mounted on the module base to provide at least one among driving forces for vibration, linear motion, rotational motion, and massage position adjustment for massaging a user's body; a unit bracket connect to the massage driving unit; and a massage unit mounted on the unit bracket to apply pressure and heat to the user's body, wherein the massage unit includes: a support shaft member made of a thermally conductive material, and fixed to the unit bracket; a heating member for transferring heat to the support shaft member; a cushion member having an opening formed in the middle thereof so that the support shaft member is inserted thereinto, rotatably mounted on the outer surface of the support shaft member to apply pressure to the user's body; a ring-shaped insert member made made of a thermally conductive metal material and inserted into the inner circumferential surface of an opening of the cushion member; and a reinforcing washer of a ring shape fit onto the support shaft member and getting in close contact with one axial side surface or both axial side surfaces of the cushion member to resist torsion stress applied to the cushion member.

### MODE FOR INVENTION

The configurations described in exemplary embodiments and the accompanying drawings of the present invention are merely preferred embodiments of the disclosed invention, and there may be various modifications that can replace the embodiments of the present specification and the drawings at the time of filing the present application.

Hereinafter, a massage module and a massage chair having the same will be described in detail with reference to the accompanying drawings. Like reference numerals denote like elements in the drawings.

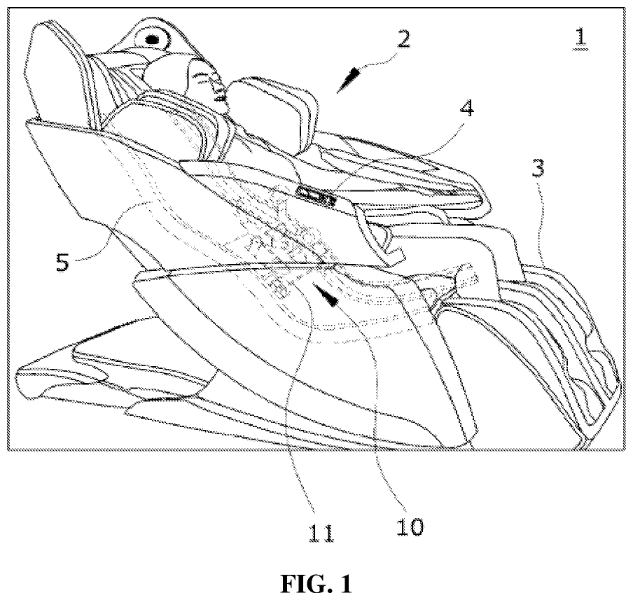

Referring to FIG. 1, the massage chair 1 may include a body massage part 2 forming an area for accommodating at least a portion of the body of a user and massaging the user's body, and a leg massage part 3 for massaging the user's legs.

The body massage part 2 is provided with a backrest portion and a seat portion so that a user can comfortably lean the user's back and head on the backrest portion and the seat portion. A massage module 10 capable of massaging the user's body parts, such as the user's shoulders, back, waist, hips, thighs, and the like, is disposed inside the backrest portion and the seat portion to move along guide rails 5 by a transfer device.

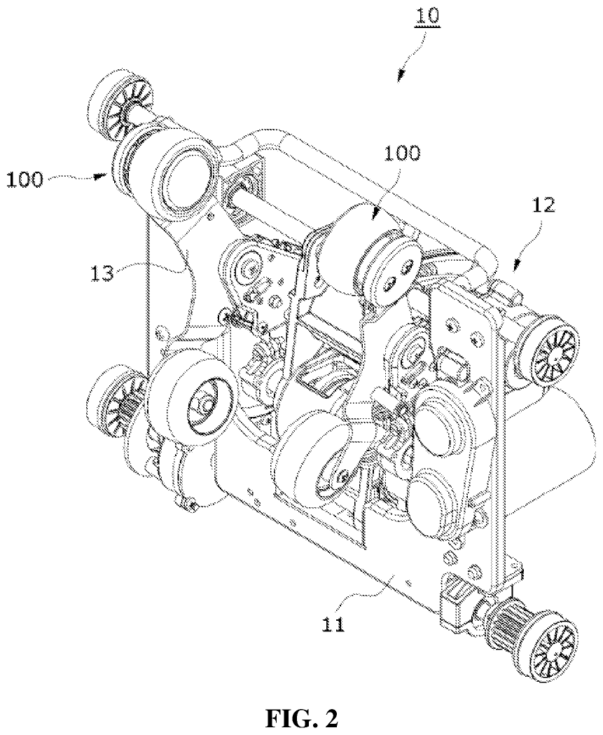

Referring to FIG. 2, the massage module 10 includes a module base 11 mounted in a massage apparatus, a massage driving unit 12 providing at least one among driving forces for vibration, linear motion, rotational motion, and massage position adjustment, unit brackets 13 connected to the massage driving unit 12, and massage units 100 mounted at upper and lower ends of the unit brackets 13 to apply pressure and heat to the user's body.

The module base 11 moves up and down by the transfer device inside the backrest portion of the massage chair 1. A plurality of massage units 100 are symmetrically installed on the front of the module base 11, and a massage driving unit 12 for operating the massage units 100 is mounted on the rear of the module base 11. The massage driving unit 12 provides a driving force performing massage actions, such as tapping or kneading, by vibrating the massage units 100 back and forth, moving the massage units 100 rectilinearly, or rotating the massage units 100 in a circular shape or an elliptical shape. The massage driving unit 12 may be configured by applying the configuration of a massage driving device providing driving forces for a kneading action, a tapping action, and a massage position (depth) adjustment of the massage units in the massage module disposed in a known massage chair.

For example, the massage driving unit may include a plurality of motors and a power transmission mechanism for transmitting a driving force of each motor to the unit bracket 110. The power transmission mechanism may be configured by appropriately combining a cam, a gear, a timing belt, a link device, and the like.

The unit bracket 13 is made of a metal plate having a substantially ‘V’ shape, and is connected to the massage driving unit 12 to receive a driving force and move back and forth and left and right.

Although two massage units 100 are coupled to the upper and lower ends of the unit brackets 13 in this embodiment, the number and position of the massage units 100 coupled to the unit brackets 13 may be applied in various ways as necessary.

All of the plurality of massage units 100 mounted in the unit brackets 13 may have a massage function and a heating function. Alternatively, only some of the plurality of massage units 100 may have the massage function and the heating function.

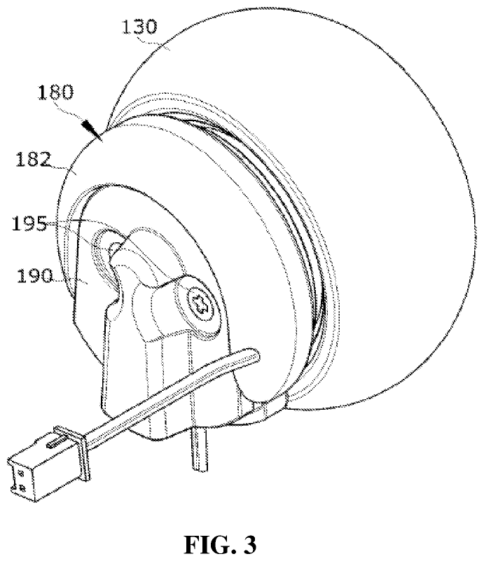

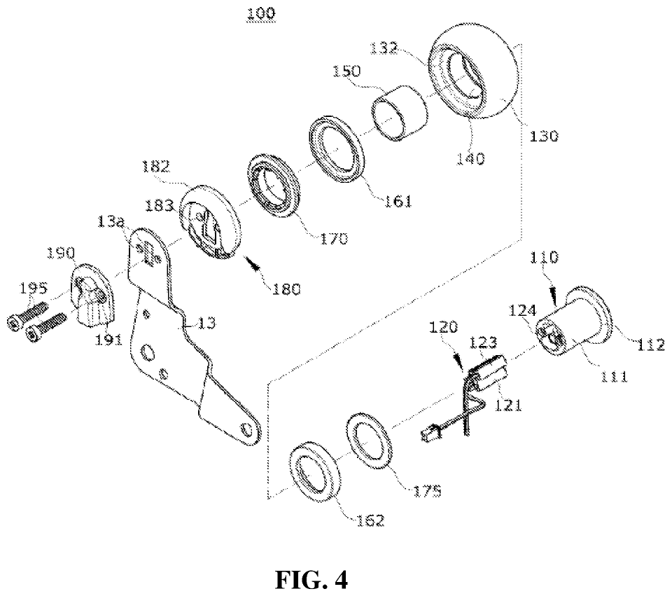

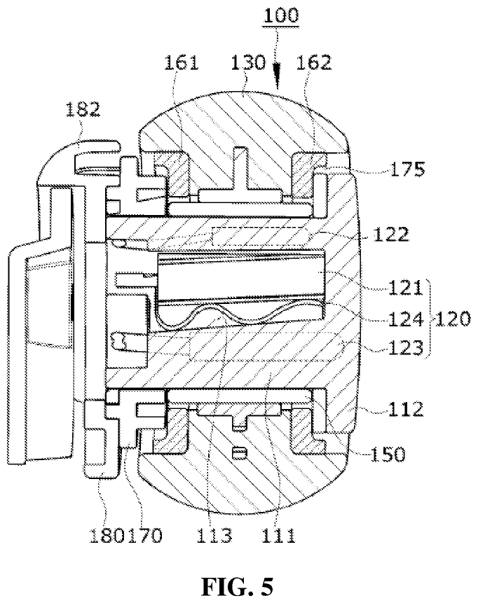

As illustrated in FIGS. 3 to 8, the massage unit 100 having the massage function and the heating function includes a support shaft member 110, a heating member 120, a cushion member 130, an insert member 140, a bearing member 150, a first reinforcing washer 161, a second reinforcing washer 162, a first protection member 170, a second protection member 175, a heat transfer cover 180, a fixing bracket 190, and a fastening member 195.

More specifically, the massage unit 100 includes a support shaft member 110 made of a thermally conductive material and fixedly mounted at an end portion of the unit bracket 13, a heating member 120 mounted to transfer heat to the support shaft member 110, a cushion member 130 rotatably mounted on the outer surface of the support shaft member 110 to apply pressure to the user's body, an insert member 140 made of a thermally conductive metal material and inserted and mounted into the inner circumferential surface of a central opening of the cushion member 130, a bearing member 150 mounted between the inner circumferential surface of the insert member 140 and the outer circumferential surface of the support shaft member 110 to rotatably support the insert member 140 and the cushion member 130 with respect to the support shaft member 110, a first reinforcing washer 161 and a second reinforcing washer 162 which are in close contact with both axial side surfaces of the cushion member 130 to resist torsion stress applied to the cushion member 130, a first protection member 170 getting in close contact with the outer surface of the first reinforcing washer 161 to prevent abrasion and deformation of the first reinforcing washer 161, a second protection member 175 disposed between the second reinforcing washer 162 and a flange portion 112 of the support shaft member 110 to prevent abrasion and deformation of the second reinforcing washer 162, a heat transfer cover 180 made of a thermally conductive material and mounted between the outer surface of the first protection member 170 and the unit bracket 13, a fixing bracket 190 coupled to one side of the unit bracket 13 in such a way that the heat transfer cover 180 is located on the other side of the unit brackets 13, and a fastening member 195 fastened to an end portion of the support shaft member 110 by sequentially penetrating fastening holes 191, 13a and 183 respectively formed in the fixing bracket 190, the unit bracket 13, and the heat transfer cover 180.

The support shaft member 110 functions as a rotary shaft of the cushion member 130 having a massage function, and also functions as a support structure for supporting the components with respect to the unit brackets 13. The support shaft member 110 includes a cylindrical body portion 111 having an end portion (axially inner end portion) fixedly coupled to the unit bracket 13 by the fastening member 195, and a flange portion 112 formed to protrude radially outward from the other end portion (axially outer end portion) of the body portion 111. The support shaft member 110 may be made of a metal material having excellent thermal conductivity, such as aluminum, to transfer heat to the insert member 140 and the cushion member 130.

A plurality of tab holes 114 having threads formed on the inner circumferential surface thereof are formed in the axially inner end portion of the body portion 111 of the support shaft member 110 so that the fastening member, such as a bolt or a screw, is fastened therethrough. In addition, a heater chamber 113 is concavely formed at the center of the body portion 111 so that the heating member 120 can be inserted and mounted therein.

The heating member 120 includes a heater 121 inserted into the heater chamber 113 formed in the body portion 111 of the support shaft member 110 to generate heat by electric power supplied from a control module 200 of the massage apparatus, a temperature sensor 122 to measure temperature for controlling the operation of the heater 121, and a bimetal 123 for automatically cutting off power supply to the heater 121 when the support shaft member 110 is heated beyond a predetermined temperature due to a failure or a malfunction of the temperature sensor 122 and restarting power supply to the heater 121 when the support shaft member 110 is cooled below a predetermined temperature. In addition, a waved heater spring 124 may be mounted on one side of the heater 121 to increase heat transfer performance and prevent vibration by pushing the heater 121 to one side of the inside of the heater chamber 113. The heater 121 may be a positive temperature coefficient (PTC) heater, but the present disclosure is not limited thereto, and various other known heaters may be applied to the heater 121.

The cushion member 130 may be formed in a roller shape or a ball shape having an opening formed in the middle thereof so that the support shaft member 110 is inserted thereinto, and may be made of a material having excellent elasticity and thermal conductivity like silicon to provide a user with a soft massage feeling, and provide heat transferred from the support shaft member 110 to the user.

The insert member 140 is inserted into the inner circumferential surface of the opening of the cushion member 130 to transfer heat of the support shaft member 110 to the cushion member 130 and maintain the shape of the cushion member 130. The insert member 140 is made of a metal material having excellent thermal conductivity, and generally has a circular ring shape. The insert member 140 and the cushion member 130 may be integrated by insert injection molding.

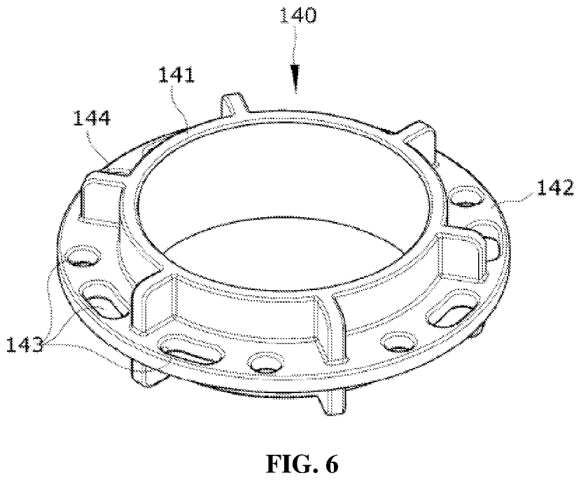

As illustrated in FIG. 6, the insert member 140 includes a circular ring-shaped inner contour portion 141 mounted along the inner circumferential surface of the opening of the cushion member 130 to be exposed to the outside, and an insert portion 142 formed on the outer circumferential surface of the inner contour portion 141 to protrude in the circumferential direction and inserted into the cushion member 130. In order to widen a contact area between the insert member 140 and the cushion member 130 and prevent separation between the insert member 140 and the cushion member 130, a plurality of through holes 143 are arranged in the circumferential direction so that a portion of the cushion member 130 can be inserted into the insert portion 142, and a plurality of protrusion ribs 144 are arranged on the insert portion 142 to be spaced apart at a predetermined interval in the circumferential direction of the insert portion 142. The protrusion ribs 144 are integrally formed with the inner contour portion 141.

The inner contour portion 141 of the insert member 140 is fit onto the outer surface of the bearing member 150 mounted on the outer surface of the support shaft member 110 and rotates along the outer surface of the bearing member 150.

The bearing member 150 is configured to rotatably support the insert member 140 and the cushion member 130 with respect to the support shaft member 110, and may be configured by applying a known sintered bearing (oilless bearing) made of a thermally conductive material, such as copper. The heat generated from the support shaft member 110 is transferred to the insert member 140 through the bearing member 150.

The first reinforcing washer 161 and the second reinforcing washer 162 are respectively inserted into grooves 132 concavely formed on both axial side surfaces of the cushion member 130, and are in close contact with both axial side surfaces of the cushion member 130 to reinforce strength of the cushion member 130. Here, the first reinforcing washer 161 is disposed to be closely arranged on one side surface of the cushion member 130 facing the unit bracket 13, and the second reinforcing washer 162 is arranged between the other side surface of the cushion member 130 and the flange portion 112 of the end of the support shaft member 110. In this embodiment, the first reinforcing washer 161 and the second reinforcing washer 162 are mounted to get in close contact with both axial side surfaces of the cushion member 130, but only one of the first reinforcing washer 161 and the second reinforcing washer 162 may be mounted to get in close contact with one side surface of the cushion member 130.

The first reinforcing washer 161 and the second reinforcing washer 162 are made of a resin material having excellent abrasion resistance and durability, such as acetal polyoxymethylene (POM), and function to prevent the cushion member 130 from being torn or damaged by resisting torsion stress generated when the cushion member 130 performs a kneading action or the like. The first reinforcing washer 161 and the second reinforcing washer 162 are formed in a circular ring shape having an ‘L’-shaped cross section, and are respectively inserted into the grooves 132 concavely formed on both axial side surfaces of the cushion member 130. As described above, in a case in which the first reinforcing washer 161 and the second reinforcing washer 162 are not formed in a flat type but formed in a circular ring shape having an ‘L’-shaped cross section, the washers according to the present invention may have more increased power resisting torsion stress of the cushion member 130 than the flat type washer.

Preferably, the inner circumferential portions of the first reinforcing washer 161 and the second reinforcing washer 162 are spaced apart from the outer surface of the body portion 111 of the support shaft member 110 at a predetermined interval in order to prevent the first reinforcing washer 161 and the second reinforcing washer 162 from being melted or thermally deformed by heat of the support shaft member 110 directly transferred to the first reinforcing washer 161 and the second reinforcing washer 162.

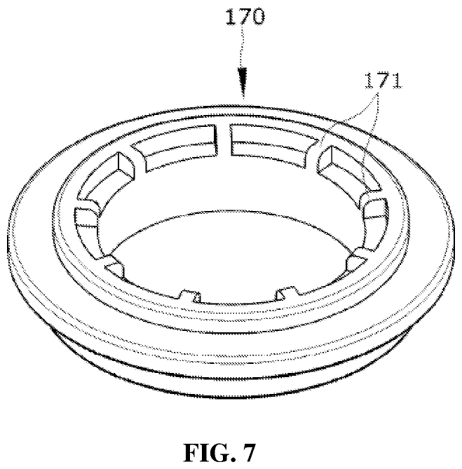

The first reinforcing washer 161 and the second reinforcing washer 162 rotate together with the cushion member 130. Accordingly, The first protection member 170 of the circular ring shape functioning to prevent abrasion and deformation of the first reinforcing washer 161 and to support the end portion of the support shaft member 110 may be mounted between the first reinforcing washer 161 and the heat transfer cover 180 to be in close contact with the first reinforcing washer 161. The first protection member 170 may be also formed of a resin material having excellent abrasion resistance and durability, such as acetal polyoxymethylene (POM). In addition, as illustrated in FIG. 7, a plurality of ribs 171 may be arranged in the circumferential direction of the first protection member 170 to minimize a contact area between the first reinforcing washer 161 and the first protection member 170, support the first reinforcing washer 161, and firmly support the outer surface of the end portion of the support shaft member 110.

The second protection member 175 of a ring shape for preventing abrasion and deformation caused by rotation of the second reinforcing washer 162 may be mounted between the second reinforcing washer 162 and the flange portion 112 of the support shaft member 110. The second protection member 175 prevents abrasion of the second reinforcing washer 162 and prevents the second reinforcing washer 162 from getting in direct contact with the flange portion 112 to prevent heat from being directly transferred to the second reinforcing washer 162 through the flange portion 112, thereby preventing thermal deformation or damage. Accordingly, the second protection member 175 is made of a resin material which has excellent wear resistance and durability and has little thermal conductivity.

The heat transfer cover 180 is formed in a metal plate shape having excellent thermal conductivity, is mounted between the outer surface of the first protection member 170 and the end portion of the unit bracket 13, and receives heat from the support shaft member 110 to transfer the heat to the user's body. The heat transfer cover 180 includes a plurality of fastening holes 183 corresponding to the tab holes 114 formed in the body portion 111 of the support shaft member 110.

The heat transfer cover 180 has a central portion getting in contact with the end portion of the body portion 111 of the support shaft member 110 to receive heat, and an edge portion protruding to the outside of the end portion of the unit bracket 13 to transfer heat to the user's body while directly or indirectly getting into close contact with the user's body part. In this instance, the heat transfer cover 180 includes a cover guard 182 formed in the circumferential direction at the edge portion thereof so that the edge portion of the heat transfer cover 180 does not give pain and discomfort to the user, and the outer surface of the cover guard 182 has a curved surface inclined downward toward the unit bracket 13. As described above, since the outer surface of the cover guard 182 is curved, it is possible to prevent pain or discomfort when the cover guard 182 applies pressure to the user's body.

The cover guard 182 functions to accommodate and conceal the fixing bracket 190 and an end portion of the unit bracket 13.

The fixing bracket 190 is coupled to one side of the end portion of the unit bracket 13. The fixing bracket 190 includes the plurality of fastening holes 191 through which the fastening member 195 passes. Also, the unit bracket 13 includes the plurality of fastening holes 13a formed to correspond to the fastening holes 191 of the fixing bracket 190.

Therefore, in a state in which the fastening holes 191 of the fixing bracket 190, the fastening holes 13a of the unit bracket 13, the fastening holes 183 of the heat transfer cover 180, and the tab holes 114 of the support shaft member 110 coincide with each other, when the fastening member 195 formed in a bolt type or a screw type is inserted and fastened into the holes, the fixing bracket 190, the heat transfer cover 180, and the support shaft member 110 are firmly fastened to the unit bracket 13.

The massage module 10 having the above-described configuration operates as follows.

When the user inputs a command to perform massage and heating functions through a control panel of a massage apparatus or an input window of a portable mobile communication terminal (referred to as a ‘smartphone’), the massage driving unit 12 of the massage module 10 is operated by the control module 200 of the massage apparatus. Accordingly, the cushion member 130 massages the user's body, such as kneading or tapping, while the massage unit 100 moves up and down and left and right.

In this instance, when electric power is applied from the control module to the heater 121, the heater 121 generates heat to heat the support shaft member 110. The heat of the support shaft member 110 is transferred to the insert member 140 through the bearing member 150, and then, is transferred to the cushion member 130 to transfer the heat to the user's body. At the same time, the heat of the support shaft member 110 is also transferred to the heat transfer cover 180, and the heat is transferred when the cover guard 182 of the heat transfer cover 180 applies pressure to the user's body.

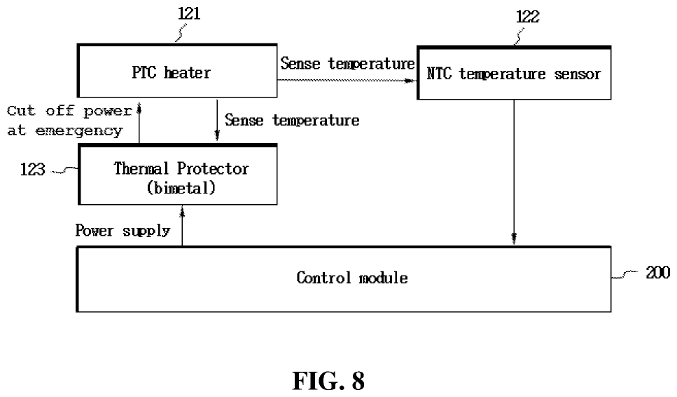

As described above, when the heating member 120 of the massage unit 100 is actuated to provide heat to the user through the cushion member 130 and the heat transfer cover 180, as illustrated in FIG. 8, the temperature sensor 122 of the heating member 120 measures temperature of the support shaft member 110 in real time and transmits a temperature information signal to the control module 200. When the temperature measured by the temperature sensor 122 reaches the target temperature, the control module cuts off power supply to the heater 121, and when the temperature measured by the temperature sensor 122 is cooled to a predetermined temperature, the control module supplies electric power to the heater 121 to generate heat, thereby maintaining the temperature of the support shaft member 110 within a predetermined temperature range.

In a case in which the temperature sensor 122 fails to operate, the bimetal 123 automatically cuts off the supply of power from the control module to the heater 121 when the support shaft member 110 is heated beyond the predetermined temperature, and restarts the power supply from the control module to the heater 121 when the support shaft member 110 is cooled below a predetermined temperature, thereby performing the heating function.

As described above, the massage module 10 according to the present invention may provide heat through the cushion member 130 by applying electric power to the heating member 120 when performing a massage action by moving the massage units 100. In this instance, since both axial sides of the cushion member 130 are supported by the first reinforcing washer 161 and the second reinforcing washer 162, even if torsion stress is generated on the cushion member 130 during the kneading action of the massage unit 100, the cushion member 130 is not deformed, and maintains its shape relatively uniform, thereby preventing deformation, damage, and separation of the cushion member 130.

Although preferred embodiments of the present invention have been described above, the present invention may use various changes, modifications, and equivalents. It is obvious that the present invention can be suitably applied by appropriately modifying the embodiments. Therefore, the description of the present invention does not limit the scope of the present invention defined by the limitation of the following claims.

1. A massage module having a heating function comprising:
a module base mounted in a massage apparatus;
a massage driving unit mounted on the module base to provide at least one among driving forces for vibration, linear motion, rotational motion, and massage position adjustment for massaging a user's body;
a unit bracket connect to the massage driving unit; and
a massage unit mounted on the unit bracket to apply pressure and heat to the user's body,
wherein the massage unit comprises:
a support shaft member made of a thermally conductive material, and fixed to the unit bracket;
a heating member for transferring heat to the support shaft member;
a cushion member having an opening formed in the middle thereof so that the support shaft member is inserted thereinto, rotatably mounted on the outer surface of the support shaft member to apply pressure to the user's body;
a ring-shaped insert member made of a thermally conductive metal material and inserted into the inner circumferential surface of an opening of the cushion member; and
a reinforcing washer of a ring shape fit onto the support shaft member and getting in close contact with one axial side surface or both axial side surfaces of the cushion member to resist torsion stress applied to the cushion member.

2. The massage module according to claim 1, wherein the reinforcing washer comprises a first reinforcing washer disposed to be in close contact with one side surface of the cushion member facing the unit bracket, and a second reinforcing washer disposed between the other side surface of the cushion member and an end portion of the supporting shaft member.

3. The massage module according to claim 2, further comprising:
a first protection member of a ring shape fit onto the support shaft member, and getting in close contact with the outer surface of the first reinforcing washer to prevent abrasion and deformation of the first reinforcing washer.

4. The massage module according to claim 3, further comprising:
a heat transfer cover mounted between the outer surface of the first protection member and the unit bracket to receive heat from the support shaft member and transfer the heat to the user's body.

5. The massage module according to claim 4, wherein the heat transfer cover comprises a cover guard formed in a circumferential direction at an edge portion thereof to accommodate and conceal the end portion of the unit bracket, and the outer surface of the cover guard has a curved surface inclined downward toward the unit bracket.

6. The massage module according to claim 2, wherein the support shaft member comprises a cylindrical body portion of which one end portion is fixedly coupled to the unit bracket, and a flange portion protruding radially outward to the other end portion of the body portion, and
wherein a second protection member of a ring shape is mounted between the second reinforcing washer and the flange portion to prevent abrasion and deformation of the second reinforcing washer.

7. The massage module according to claim 1, wherein the heating member is inserted into a space formed in the support shaft member.

8. The massage module according to claim 7, wherein the heating member comprises a heater generating heat by electric power supplied from an external control module, a temperature sensor measuring temperature to control the operation of the heater, and a bimetal for automatically cutting off power supply to the heater when the support shaft member is heated beyond a predetermined temperature due to a failure of the temperature sensor and restarting power supply to the heater when the support shaft member is cooled below a predetermined temperature.

9. The massage module according to claim 1, wherein the insert member comprises a circular ring-shaped inner contour portion mounted along the inner circumferential surface of the opening of the cushion member to be exposed to the outside, an insert portion formed on the outer circumferential surface of the inner contour portion, inserted into the cushion member, and having a plurality of through holes arranged in the circumferential direction so that a portion of the cushion member can be inserted, and protrusion ribs arranged on the insert portion to be spaced apart at a predetermined interval in the circumferential direction of the insert portion.
